(19) United States
(12) Patent Application Publication
(10) Pub. No.: US 2021/0187862 A1
(43) Pub. Date: Jun. 24, 2021

(54) CARRIER PLATFORMS CONFIGURED FOR SENSING RESIN LIGHT ABSORPTION DURING ADDITIVE MANUFACTURING

(71) Applicant: Carbon, Inc., Redwood City, CA (US)

(72) Inventors: Rene Lopez, Redwood City, CA (US); Bernard Carreon, Berkeley, CA (US)

(21) Appl. No.: 17/106,614

(22) Filed: Nov. 30, 2020

Related U.S. Application Data
(60) Provisional application No. 62/951,488, filed on Dec. 20, 2019.

(51) Int. Cl. B29C 64/393; B29C 64/245; B29C 64/124; B33Y 10/00; B33Y 30/00; B33Y 50/02

(52) U.S. Cl. CPC B29C 64/393; B29C 64/245; B33Y 50/02; B33Y 10/00; B33Y 30/00; B29C 64/124

(57) ABSTRACT

A carrier platform for an additive manufacturing apparatus includes (a) a build member having a top portion and a planar build surface, on which build surface an object can be produced by additive manufacturing; (b) an elevator coupler connected to the build member top portion; and (c) a reflector operatively associated with the build surface, the reflector having a reflective surface facing away from the build surface.

### RELATED APPLICATIONS

This application claims priority to U.S. Provisional Application Ser. No. 62/951,488, filed Dec. 20, 2019, the disclosure of which is incorporated herein in its entirety.

### FIELD OF THE INVENTION

The present invention concerns apparatus for producing objects by additive manufacturing, and methods of monitoring of heat patterns during such production.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

Two important characteristics of stereolithography resins are: (i) their light absorption (typically expressed as either the “alpha” or the penetration depth (D_{P})), and (ii) their dose-to-cure (typically expressed as Dc, but also expressed as the critical exposure (E_{c})). See generally J. Tumbleston et al., Performance Optimization in Additive Manufacturing, PCT Publication No. WO 2019/074790 (18 Apr. 2019). Currently, a resin's light absorption is measured in specialized instrumentation. However, the light absorption of resins tend to vary from batch to batch of what is otherwise the same resin, and can even vary over time for the same batch of resin. Furthermore, the printers themselves can differ from one another in their light source wavelength, rending any light absorption characterizations done in external instrumentation only an approximation of what is present for a specific resin on a specific machine. This can cause a variety of problems with the production of objects across different machines, and at different times. It would be extremely useful to have a printer that characterizes the resin itself and uses that information locally to adjust light dose for the production of an object on that machine, with the resin loaded onto that machine, at that time.

### SUMMARY OF THE INVENTION

In some embodiments, a carrier platform for an additive manufacturing apparatus includes (a) a build member having a top portion and a planar build surface, on which build surface an object can be produced by additive manufacturing; (b) an elevator coupler connected to the build member top portion; and (c) a reflector operatively associated with the build surface, the reflector having a reflective surface facing away from the build surface.

In some embodiments, the build surface and the reflective surface are parallel.

In some embodiments, the reflective surface is planar, or the reflective surface is contoured (e.g., patterned, textured, convex, concave, or a combination thereof).

In some embodiments, the reflective surface is spaced outward from the build surface by a maximum distance (e.g., d₁) of not more than 100 or 200 microns; the reflective surface is spaced inward from the build surface by a maximum distance (e.g., d₂) of not more than 100 or 200 microns; or the reflective surface and the build surface are coplanar (e.g., d₀).

In some embodiments, the reflector is comprised of a metal (e.g., aluminum), an inorganic material (e.g., glass), a polymer (e.g., polycarbonate), or a combination thereof (e.g., a metal back-coating on a polymer or inorganic, light transmissive, body).

In some embodiments, a bottom-up additive manufacturing apparatus includes (a) a frame (17); (b) a resin cassette operatively associated with the frame, the resin cassette comprising (i) a light transmissive window and (ii) a circumferential frame connected to and surrounding the window, the window and frame together forming a well configured to receive a light polymerizable resin; (c) a light source positioned below the resin cassette and positioned for projecting patterned light through the window; (d) a carrier platform as described above positioned above the window; (e) a drive including an elevator operatively associated with the carrier platform and the frame and configured for advancing the carrier platform and the resin cassette away from one another; and (f) a camera associated with the frame and positioned to detect light emitted from the light source, projected through the window, and reflected by the reflector back through the window.

In some embodiments, the apparatus includes a heater, a cooler, or both a heater and a cooler operatively associated with the window.

In some embodiments, a method of determining the light absorption of a light polymerizable resin includes (a) filing a resin cassette in an apparatus described herein with the resin; (b) emitting light from the light source; (c) detecting light emitted from the light source, projected through the window, and reflected by the reflector back through the window when the carrier platform is at a known position; (d) repeating step (c) with the carrier platform at a plurality of different known positions until a plurality of reflected light samples are obtained; and (e) determining the light absorption of the light polymerizable resin from the plurality of reflected light samples.

In some embodiments, a method of making an object from a light polymerizable resin and a data file (e.g., a CAD file, an .stl file, etc.), includes (a) filling a resin cassette in an apparatus as described herein with the resin; (b) emitting light from the light source; (c) detecting light emitted from the light source, projected through the window, and reflected by the reflector back through the window when the carrier platform is at a known position; (d) repeating step (c) with the carrier platform at a plurality of different known positions until a plurality of reflected light samples are obtained; and (e) determining the light absorption of the light polymerizable resin from the plurality of reflected light samples; and (f) producing the object from the data file and the resin by intermittently and/or continuously exposing the resin to patterned light from the light source to photopolymerize the resin, while advancing the carrier platform and the resin cassette away from one another; wherein the exposing step is carried out at a time and/or intensity (i.e., dose) in response to the determined light absorption (i.e., a lower dose for resins that have greater light absorption, a higher dose for resins that have lesser light absorption, as compared to one another).

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a schematic illustration of one embodiment of a carrier platform and apparatus as described herein, prior to producing an object thereon.

FIG. 2 is a schematic illustration similar to FIG. 1, except that production of an object thereon has begun.

FIG. 3 schematically illustrates another embodiment of a carrier platform as described herein, where the reflector surface is spaced outward from, or projects away from, the build surface.

FIG. 4 schematically illustrates another embodiment of a carrier platform as described herein, where the reflector surface is spaced inward from, or recessed from, the build surface.

FIG. 5 schematically illustrates still another embodiment of a carrier platform as described herein, where the reflector surface is patterned, and coplanar with the build surface.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

1. Resins and Additive Manufacturing Steps.

Resins for additive manufacturing are known and described in, for example, U.S. Pat. Nos. 9,211,678; 9,205,601; and 9,216,546 to DeSimone et al. In addition, dual cure resins useful for carrying out some embodiments of the present invention are known and described in U.S. Pat. Nos. 9,676,963, 9,453,142 and 9,598,606 to Rolland et al., and in U.S. Pat. No. 10,316,213 to Arndt et al. Particular examples of suitable dual cure resins include, but are not limited to, Carbon Inc. medical polyurethane, elastomeric polyurethane, rigid polyurethane, flexible polyurethane, cyanate ester, epoxy, and silicone dual cure resins, all available from Carbon, Inc., 1089 Mills Way, Redwood City, Calif. 94063 USA.

Apparatus for carrying out bottom-up stereolithography, which can be adapted or improved as described herein, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017); L. Robeson et al., PCT Patent Pub. No. WO 2015/164234 (see also U.S. Pat. Nos. 10,259,171 and 10,434,706); C. Mirkin et al., PCT Patent Pub. No. WO 2017/210298 (see also US Pat. App. US 2019/0160733); B. Feller, US Pat App. Pub. No. US 2018/0243976 (published Aug. 30, 2018); M. Panzer and J. Tumbleston, US Pat App Pub. No. US 2018/0126630 (published May 10, 2018); and K. Willis and B. Adzima, US Pat App Pub. No. US 2018/0290374 (Oct. 11, 2018).

2. Additive Manufacturing Apparatus

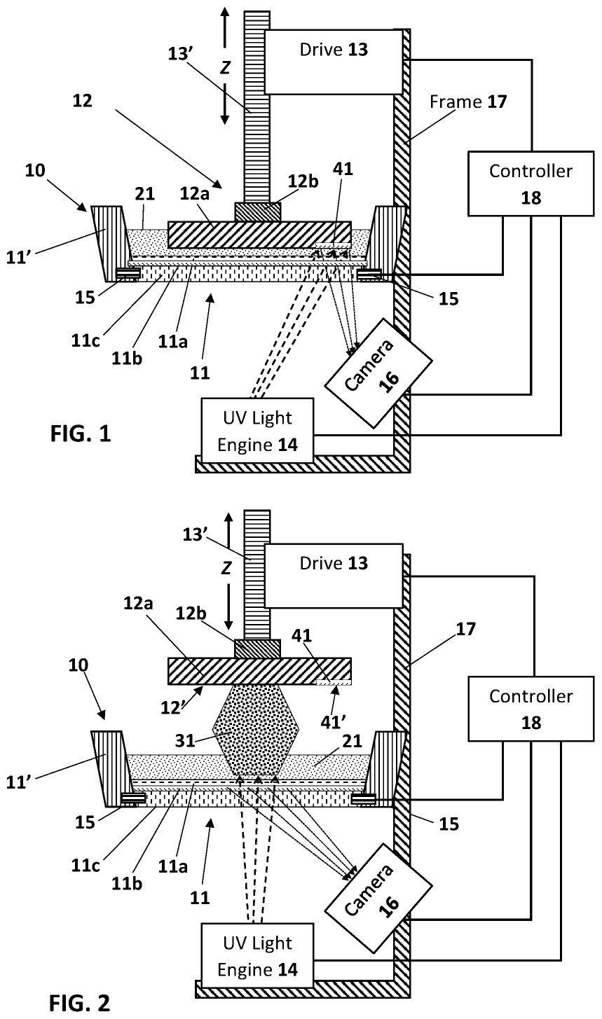

Referring to FIGS. 1-2, an additive manufacturing apparatus according to embodiments of the present invention is illustrated. As shown in the Figures, a bottom-up additive manufacturing apparatus includes (a) a frame (17); b) a resin cassette (10); (c) a light source (14) positioned below the resin cassette (10) and positioned for projecting patterned light through a window (11) of the resin cassette (10); (d) a carrier platform (12) positioned above the window (11) and operatively associated with the frame (17); and (e) a drive (13) operatively associated with a carrier platform (12) and the frame (17) and configured for advancing the carrier platform (12) and the resin cassette (10) away from one another. Objects 31 may be produced on the carrier platform (12) from resin 21 in the resin cassette (10). The apparatus may further include a heater/cooler (15), a controller (18), and a UV light engine (14). The UV light engine (14) is configured to project patterned light through the transparent window (11) to thereby cure the resin 21 in an additive manufacturing process to produce the object (31) on the carrier platform (12).

As discussed herein, the window (11) may optionally include a fluorophore layer.

The apparatus includes a camera (16), which is associated with (e.g., mounted on) the frame (17). The camera (16) is positioned to detect light reflected from the reflector 41 on the carrier platform, and optionally fluorescence from the fluorophore layer.

The controller (18) may be configured to control the projections of the UV light engine (14), the movement of the carrier platform (12) in the Z direction away from the resin cassette (10), the camera (16) and/or the heater/cooler (15).

3. Carrier Platforms.

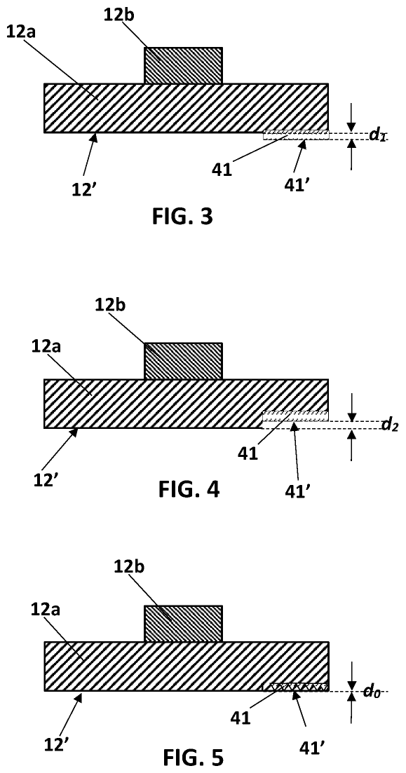

As illustrated in FIGS. 3-5, a carrier platform (12) for an additive manufacturing apparatus includes a build member (12a) having a top portion and a planar build surface (12′), on which build surface an object can be produced by additive manufacturing. An elevator coupler (12b) is connected to the build member top portion; and a reflector (41) is operatively associated with the build surface. The reflector has a reflective surface (41′) facing away from the build surface.

In some embodiments, the build surface and the reflective surface are parallel.

In some embodiments, the reflective surface (41′) is planar (FIGS. 3-4). However, the reflective surface (41′) may also be contoured (e.g., patterned, textured, convex, concave, or a combination thereof) (FIG. 5)

The reflective surface (41′) and the build surface (12′) may be spaced inward or outward from one another or may be coplanar. As shown in FIG. 3, the reflective surface (41′) is spaced outward from the build surface (12′) by a maximum distance (e.g., d₁) of not more than 100 or 200 microns. As shown in FIG. 4, the reflective surface (41′) is spaced inward from the build surface (12′) by a maximum distance (e.g., d₂) of not more than 100 or 200 microns. As shown in FIG. 5, the reflective surface (41′) and the build surface (12′) are coplanar (e.g., d₀).

In some embodiments, the reflector (41) is comprised of a metal (e.g., aluminum), an inorganic material (e.g., glass), a polymer (e.g., polycarbonate), or a combination thereof (e.g., a metal back-coating on a polymer or inorganic, light transmissive, body).

Any suitable manual or automatic elevator coupler (12b) can be used, including mechanical couplers (with or without pneumatic and/or hydraulic actuation features), electromagnetic couplers, etc., including combinations thereof.

The reflector is in some embodiments a mirror, but can include surface features such as convex, concave or offset regions (e.g., as in a “cateye” reflector), tints or pigments, (so long as sufficient light at the relevant wavelength is reflected). The reflector can be a sheet material or can be a region of reflective particles coated on the back surface of the carrier platform.

4. Resin Cassettes and Windows Thereof.

As illustrated in the Figures, a resin cassette (10) for an additive manufacturing apparatus includes a light transmissive window (11) and a circumferential frame (12) connected to and surrounding the window (11). The window (11) and frame (11′) together form a well configured to receive a light polymerizable resin (21).

A fluorophore layer is optionally included in or on the window. The fluorophore may include a fluorone dye (e.g., a rhodamine, such as rhodamine B or rhodamine 6G). The fluorophore fluoresces in the visible range (i.e., emits light at a peak emission wavelength between 380 and 740 nanometers). Additional examples of fluorophores that can be used in the methods and apparatus described herein include, but are not limited to: zinc oxide quantum dots; N,N-bis(2,5-di-tertbutylphenyl)-3,4,9,10-perylenedi carboximide (BTBP), and dichlorotris-(1,10-phenanthroline)-ruthenium(II)hydrate (Ru(phe)3) (see, e.g., C. Hoera et al., An integrated microfluidic chip enabling control and spatially resolved monitoring of temperature in micro flow reactors, Ana. Bioanal. Chem (published online 7 Nov. 2014)).

As illustrated, the window (11) includes various layers, such as a sandwich of a top portion (11a), a middle portion (11b) and a bottom portion (11c) (e.g., a bottom portion having a thickness of at least 1, 2 or 3 millimeters). The fluorophore layer in or one of the layers (11a, 11b, 11c). For example, the florophore layer may be either between the top portion (11a) and the bottom portion (11c) or included in the top portion (11a). In some embodiments, the fluorophore layer is on the bottom surface (11c). In some embodiments, the window (11) has a total thickness of not more than 100 microns.

In some embodiments, the window (11), or in some embodiments the window bottom portion (11c), comprises glass, sapphire, quartz, transparent aluminum (aluminum oxynitride; ALON), or magnesium fluoride.

In some embodiments, the top portion (11a) comprises a polymer (e.g., an oxygen-permeable polymer such as an amorphous fluoropolymer), optionally with the fluorophore dispersed therein.

In some embodiments, the at least one intermediate layer (11b) (e.g., a second polymer layer, such as a polydimethylsiloxane (PDMS) layer) between the top portion (11a) and the bottom portion (11c), includes the fluorophore layer distributed therein.

Although the window (11) is illustrated with three layers (11a, 11b, 11c), it should be understood that the fluorophore layer may be incorporated into windows having various configurations with additional layers or on a single layer window or in a window configuration having only two layers. In some embodiments, the intermediate layer (11b) may include additional layers.

In some embodiments, the camera (16) is configured to detect regional variations in fluorescence across the window (11) (i.e., a fluorescence map in both the X and Y directions), as well as light reflected from the carrier platform reflector.

5. Methods of Operation

A. General In some embodiments, a method of making the object (31) from a light polymerizable resin (21) and a data file (e.g., a CAD file, an .stl file, etc.), includes filling the resin cassette (10) with resin (21) and producing the object (31) from the data file and the resin (21) by intermittently and/or continuously exposing the resin (21) to patterned light from the light source of the UV light engine (14) to photopolymerize the resin (21), while advancing the carrier platform (12) and the resin cassette (10) away from one another. Fluorescence from the fluorescence layer may be detected during the producing step, with the intensity of the fluorescence corresponding to a temperature of the window (11).

B. Heat detection. In some embodiments, variations of fluorescence may be detected across the window, such as to produce a fluorescence map or heat map in both the X and Y directions.

In some embodiments, fluorescence detecting by the camera (16) is carried out a plurality of times during the production of the object (31).

In some embodiments, the resin (21) includes a photocalaytic system, and the fluorophore has an absorption at the peak absorption wavelength of the photocatalytic system that is sufficiently low to avoid undue interference with photopolymerization of the light polymerizable resin during production of the object (31) (e.g., the fluorophore absorbs not more than 1, 5, 10 or 20 percent the peak absorbance level of the photocatalytic system).

In some embodiments, the detected fluorescence data is saved or stored in association with a unique identifier for the produced object (31) and/or the data file is stored in a storage media (locally or on the cloud). In some embodiments, at least one parameter of the production of the object (31) may be modified in response to the detected fluorescence.

The apparatus can include heaters and/or coolers (15) operatively associated with the window (11) and the controller (18). Any suitable devices can be used, including resistive heaters, Peltier coolers, infrared heaters, etc., including combinations thereof. The heaters/coolers are preferably directly included in the resin cassette, preferably in direct contact with the window itself, or in the case of infrared heaters (not shown) can be positioned to project into the resin through the window.

As noted above, the process may further include: (d) saving the detected fluorescence data in association with a unique identifier for the produced object and/or the data file used to produce the object in a storage media (locally or on the cloud); and/or (e) modifying at least one parameter of the producing step in response to the detected fluorescence These steps may be implemented in any of a variety of ways, including but not limited to: reducing light intensity in exposure regions where heat is greater than expected (in this or a subsequent print of the same object (e.g., as defined by a data file such as a CAD file or stl file for that object)); increasing light intensity in exposure regions where heat is less than expected (in this or a subsequent print of the same object); slowing print speed when heat is greater than expected (in this or a subsequent print of the same object); speeding print speed when heat is less than expected (in this or a subsequent print of the same object); saving the detected fluorescence in association with a unique identifier for the object and/or the data file from which the object is produced; reducing heater output, and/or increasing cooler activity, when heat is greater than desired; increasing heater output, and/or reducing cooler activity, when heat is less than desired; ceasing print when significantly less heat is generated or when the heat map does not match the expected heat profile (indicating the object has fallen off or partially detached from the carrier platform, an exposure slice was missed, or the like); ceasing print when the detected fluorescence is so different from what is expected that it indicates an incorrect resin, or a defective resin, has been placed in the resin cassette; correcting part geometry by (in this print or a subsequent print): by increasing exposure regions where parts are too small or decrease exposure regions where parts are too big as indicated by the detected fluorescence heat map.

Accordingly the temperature and/or temperature gradient of the window may be recorded and/or monitored using the detected fluorescence heat map. In some embodiments, the heaters/coolers (15) of the window (11) may be operated based on the detected fluorescence heat map.

C. Determining resin light absorption. In some embodiments, the light incident and leaving the window (I⁺ and I⁻, respectively) undergo a process of decay by absorption (a) and scattering (R) along the path Z according to the following equation:

$$( \begin{matrix}{I}^{+} \\ {I}^{-}\end{matrix} ) = C {e}^{\sqrt{{( ∝ + R )}^{2} - {R}^{2} Z}} ( \begin{matrix}R \\ ∝ + R + \sqrt{∝ + R + {( ∝ + R )}^{2} - {R}^{2}}\end{matrix} ) + D {\overline{e}}^{\sqrt{{( ∝ + R )}^{2} - {R}^{2} Z}} ( \begin{matrix}∝ + R + \sqrt{∝ + R + {( ∝ + R )}^{2} - {R}^{2}} \\ R\end{matrix} )$$

Where C and D are constants to be set up by boundary conditions in the region of interest. With an incident light intensity I₀ and the mirror surface located at Z=Zo, the appropriate boundary conditions will be:

I⁺(0)=I₀ I⁻(Zo)=I₀⁺(Z₀)

Resulting in determined values for the C and D constants as:

$$C = \frac{{I}_{0}}{R + ( ∝ + R + \sqrt{{( a + R )}^{2} - {R}^{2}} ) {e}^{2 \sqrt{{( ∝ + R )}^{2} - {R}^{2} {Z}_{0}}}}$$

$$D = \frac{{I}_{0}}{R + ( ∝ + R + \sqrt{{( a + R )}^{2} - {R}^{2}} ) + R {\overline{e}}^{2 \sqrt{{( ∝ + R )}^{2} - {R}^{2} {Z}_{0}}}}$$

Thus, measuring the reflected light as function of the mirror position Z₀, that is fitting the intensity I⁻(Z₀), the unknown parameters α and R can be found.

The apparatus can include a local controller that contains and executes operating instructions for the production of a three dimensional object on that apparatus, typically from an object data file entered into the controller by the user. Along with the basic three-dimensional image of the object that is typically projected for photopolymerization (along with movement of the carrier and build surface away from one another in the Z direction), the operating instructions can include or generate process parameters such as: light intensity; light exposure duration; inter-exposure duration; speed of production; step height; height and/or duration of upstroke in a stepped or reciprocal operating mode; height and/or duration of downstroke in a reciprocal operating mode; rotation speed for pumping viscous polymerizable liquid; resin heating temperature; and/or resin cooling temperature; rotation speed and frequency, etc. (see, e.g., Ermoshkin et al., Three-dimensional printing with reciprocal feeding of polymerizable liquid PCT Patent Application Pub. No. WO 2015/195924 (published 23 Dec. 2015); Sutter et al., Fabrication of three dimensional objects with multiple operating modes, PCT Patent Application Publication No. WO 2016/140886 (published 9 Sep. 2016); J. DeSimone et al., Methods and apparatus for continuous liquid interface production with rotation, PCT Patent Application WO 2016/007495 (published 14 Jan. 2016); see also J. DeSimone et al., U.S. Pat. No. 9,211,678, and J. Batchelder et al., Continuous liquid interface production system with viscosity pump, US Patent Application Publication No. US 2017/0129169 (published 11 May 2017).

The controller of the additive manufacturing apparatus contains, as noted above, operating instructions for implementing the production of an object on that apparatus. In general, such operating instructions will specify various process parameters. Particular process parameters will depend on the operating mode of the apparatus (e.g., continuous, stepped, reciprocal or “pumped”, etc., including combinations thereof (i.e., a “mixed operating mode”). The process parameters may be fixed or static, or may be dynamically generated on an object-by-object basis depending on factors such as part size, part density, etc.

As noted above, the process parameters implemented during additive manufacturing will be based on, and optimized for, the “expected” physical characteristic(s) of the resin from which the object is to be produced. Such expected characteristics may be determined as described above, and may be updated from time to time (e.g., by pushing instruction updates to the additive manufacturing apparatus controller over the internet).

In general, the controller will be configured to produce objects from a particular resin based on, among other things, the expected or standard light absorption for that resin. The light absorption for the resin more specifically and contemporaneously determined on the apparatus as described herein can then be compared to previously determined standard characteristics for a particular resin type, and the dose of light delivered to the resin adjusted accordingly when the absorption is greater or less than expected. Thus, the dose or amount of light is adjusted in response to the determined light absorption. Specifically, when light absorption of the resin is less than expected, the duration and/or intensity of light exposure during additive production can be increased, and when the light absorption of the resin is greater than expected, the duration and/or intensity of light exposure during additive production can be decreased, as compared to one another.

Standard characteristics can be determined by any suitable technique, such as by preparing an initial “gold standard” batch of a resin blend, by selecting average or median values from a group of resin blends, etc. Standard characteristics can remain fixed, or periodically updated. Expected or standard light absorption can be expressed in any manner and measured by any suitable technique, such as described in, for example, Rapid Prototyping and Manufacturing: Fundamentals of Stereolithography, pp. 87-91 (P. Jacobs, Ed. 1992); Stereolithography and Other RP&M Technologies: from Rapid Prototyping to Rapid Manufacturing, pp. 54-56 (P. Jacobs, Ed. 1996)(for penetration depth, Dₚ), and in J. Tumbleston et al., Continuous liquid interface production of 3D objects, Science 347, 1349-1352 (20 Mar. 2015) (for resin absorption coefficient, or alpha).

The foregoing is illustrative of the present invention, and is not to be construed as limiting thereof. The invention is defined by the following claims, with equivalents of the claims to be included therein.

We claim:

1. A carrier platform for an additive manufacturing apparatus, comprising:
(a) a build member having a top portion and a planar build surface, on which build surface an object can be produced by additive manufacturing;
(b) an elevator coupler connected to said build member top portion; and
(c) a reflector operatively associated with said build surface, said reflector having a reflective surface facing away from said build surface.

2. The carrier platform of claim 1, wherein said build surface and said reflective surface are parallel.

3. The carrier platform of claim 1, wherein said reflective surface is planar.

4. The carrier platform of claim 1, wherein said reflective surface is contoured.

5. The carrier platform of claim 4, wherein said reflective surface is patterned, textured, convex, concave, or a combination thereof.

6. The carrier platform of claim 1, wherein said reflective surface is spaced outward from said build surface by a maximum distance of not more than 100 or 200 microns.

7. The carrier platform of claim 1, wherein said reflective surface is spaced inward from said build surface by a maximum distance of not more than 100 or 200 microns.

8. The carrier platform of claim 1, wherein said reflective surface and said build surface are coplanar.

9. The carrier platform of claim 1, wherein said reflector is comprised of a metal, an inorganic material, a polymer, or a combination thereof.

10. The carrier platform of claim 9, wherein said reflector comprises a metal back-coating on a polymer or inorganic, light transmissive, body.

11. A bottom-up additive manufacturing apparatus, comprising:
(a) a frame;
(b) a resin cassette operatively associated with said frame, the resin cassette comprising (i) a light transmissive window and (ii) a circumferential frame connected to and surrounding said window, said window and frame together forming a well configured to receive a light polymerizable resin;
(c) a light source positioned below said resin cassette and positioned for projecting patterned light through said window;
(d) a carrier platform positioned above said window, wherein said carrier platform comprises:
(i) a build member having a top portion and a planar build surface, on which build surface an object can be produced by additive manufacturing;
(ii) an elevator coupler connected to said build member top portion; and
(iii) a reflector operatively associated with said build surface, said reflector having a reflective surface facing away from said build surface;
(e) a drive including an elevator operatively associated with said carrier platform and said frame and configured for advancing said carrier platform and said resin cassette away from one another; and
(f) a camera associated with said frame and positioned to detect light emitted from said light source, projected through said window, and reflected by said reflector back through said window.

12. The apparatus of claim 11, further comprising a heater, a cooler, or both a heater and a cooler operatively associated with said window.

13. The apparatus of claim 11, wherein said build surface and said reflective surface are parallel.

14. The apparatus of claim 11, wherein said reflective surface is planar.

15. The apparatus of claim 11, wherein said reflective surface is contoured.

16. The apparatus of claim 15, wherein said reflective surface is patterned, textured, convex, concave, or a combination thereof.

17. The apparatus of claim 11, wherein said reflective surface is spaced outward from said build surface by a maximum distance of not more than 100 or 200 microns.

18. The apparatus of claim 11, wherein said reflective surface is spaced inward from said build surface by a maximum distance of not more than 100 or 200 microns.

19. The apparatus of claim 11, wherein said reflective surface and said build surface are coplanar.

20. A method of determining the light absorption of a light polymerizable resin, comprising:
(a) filing a resin cassette in an apparatus with said resin, wherein said apparatus comprises a bottom-up additive manufacturing apparatus comprising:
a frame;
a resin cassette operatively associated with said frame, the resin cassette comprising (i) a light transmissive window and (ii) a circumferential frame connected to and surrounding said window, said window and frame together forming a well configured to receive a light polymerizable resin;
a light source positioned below said resin cassette and positioned for projecting patterned light through said window;
a carrier platform positioned above said window, wherein said carrier platform comprises:
a build member having atop portion and a planar build surface, on which build surface an object can be produced by additive manufacturing;
an elevator coupler connected to said build member top portion; and
a reflector operatively associated with said build surface, said reflector having a reflective surface facing away from said build surface;
a drive including an elevator operatively associated with said carrier platform and said frame and configured for advancing said carrier platform and said resin cassette away from one another; and
a camera associated with said frame and positioned to detect light emitted from said light source, projected through said window, and reflected by said reflector back through said window;
(b) emitting light from said light source;
(c) detecting light emitted from said light source, projected through said window, and reflected by said reflector back through said window when said carrier platform is at a known position;
(d) repeating step (c) with said carrier platform at a plurality of different known positions until a plurality of reflected light samples are obtained; and
(e) determining the light absorption of said light polymerizable resin from said plurality of reflected light samples.

21. A method of making an object from a light polymerizable resin and a data file, comprising:
(a) filing a resin cassette in an apparatus with said resin, wherein said apparatus comprises a bottom-up additive manufacturing apparatus comprising:
a frame;
a resin cassette operatively associated with said frame, the resin cassette comprising (i) a light transmissive window and (ii) a circumferential frame connected to and surrounding said window, said window and frame together forming a well configured to receive a light polymerizable resin;
a light source positioned below said resin cassette and positioned for projecting patterned light through said window;
a carrier platform positioned above said window, wherein said carrier platform comprises:
a build member having atop portion and a planar build surface, on which build surface an object can be produced by additive manufacturing;
an elevator coupler connected to said build member top portion; and
a reflector operatively associated with said build surface, said reflector having a reflective surface facing away from said build surface;
a drive including an elevator operatively associated with said carrier platform and said frame and configured for advancing said carrier platform and said resin cassette away from one another; and
a camera associated with said frame and positioned to detect light emitted from said light source, projected through said window, and reflected by said reflector back through said window;
(b) emitting light from said light source;
(c) detecting light emitted from said light source, projected through said window, and reflected by said reflector back through said window when said carrier platform is at a known position;
(d) repeating step (c) with said carrier platform at a plurality of different known positions until a plurality of reflected light samples are obtained; and
(e) determining the light absorption of said light polymerizable resin from said plurality of reflected light samples; and
(f) producing said object from said data file and said resin by intermittently and/or continuously exposing said resin to patterned light from said light source to photopolymerize said resin, while advancing said carrier platform and said resin cassette away from one another;
wherein said exposing step is carried out at a time and/or intensity responsive to said determined light absorption.

22. The method of claim 21, wherein the time and/or intensity of said exposing step comprises a dose, said method further comprises selecting a lower dose for resins that have greater light absorption and a higher dose for resins that have lesser light absorption as compared to one another.
